(19) United States
(12) Patent Application Publication
(10) Pub. No.: US 2026/0012452 A1
(43) Pub. Date: Jan. 8, 2026

(54) METHOD AND SYSTEM OF SECURELY ADDING AN EDGE DEVICE OPERATING IN A PUBLIC NETWORK TO AN SD-WAN

(71) Applicant: VeloCloud Networks, LLC, Santa Clara, CA (US)

(72) Inventors: Muthukrishnan Manoharan, Chennai (IN); Manigandan Elumalai, Chennai (IN); Thomas Harold Speeter, San Martin, CA (US); Prakash Kasiviswanathan Parameshwar, Chennai (IN); Stephen Lynn, Ashburn, VA (US)

(21) Appl. No.: 19/308,697

(22) Filed: Aug. 25, 2025

Related U.S. Application Data
(63) Continuation of application No. 17/966,820, filed on Oct. 15, 2022, now Pat. No. 12,425,395.

(30) Foreign Application Priority Data
Jan. 15, 2022 (IN) 202241002421

(51) Int. Cl. H04L 9/40

(52) U.S. Cl. CPC H04L 63/0853

(57) ABSTRACT

Some embodiments of the invention provide, for a network manager of a secure SD-WAN (software-defined wide-area network), a method of securely adding an edge device, which operates at a branch location in a public network, to the SD-WAN. The method provides, to an activation service hosted on the public network, a record for the edge device that is to be added to the SD-WAN securely, the record for use by the activation service to authenticate the edge device. The method receives a first notification from the activation service indicating the edge device has been authenticated. The method receives a second notification from a verification service indicating the authenticated edge device has been verified. Based on the first and second notifications, the method provides to the activation service (i) a set of configuration data for the edge device and (ii) a set of authentication data for the edge device. The activation service provides the set of configuration data and the set of authentication data to the edge device to use to join the SD-WAN.

### CLAIM OF BENEFIT TO PRIOR APPLICATION

The present application is a continuation application of U.S. patent application Ser. No. 17/966,820 filed on Oct. 15, 2022, and published on Jul. 20, 2023, under Publication No. 2023-023845. U.S. patent application Ser. No. 17/966,820 claims the benefit of Indian patent application Ser. No. 20/224,1002421, filed on Jan. 15, 2022, which is incorporated herein by reference in its entirety for all purposes.

### BACKGROUND

Today, network managers and controllers, such as VMware, Inc.'s SD-WAN Orchestrator, act as a brain for the SD-WAN solution as they store, distribute, and compute all of the configurations needed for SD-WAN forwarding elements (e.g., SD-WAN Edge, SD-WAN Gateway, etc.) to operate. Without a mechanism to securely validate the identities of edge devices before they are added to the secure network, such an Orchestrator can become compromised, and sensitive network configuration details may be leaked (e.g., topology, network addresses, branch locations, etc.). Such a breach of the Orchestrator could prove to be a threat to the entire SD-WAN infrastructure.

### BRIEF SUMMARY

Some embodiments of the invention provide a method for a network manager (e.g., SD-WAN orchestrator from VMware, Inc.) of a secure SD-WAN (software-defined wide-area network) to securely add an edge device, which operates at a branch location in a public network, to the SD-WAN. The SD-WAN enables high performance and reliable branch network access across multiple different clouds and applications. To an activation service hosted on the public network and acting as an intermediary between the edge device and the network manager, the network manager provides a record for the edge device that is to be added to the SD-WAN securely, the record for use by the activation service to authenticate the edge device. The network manager receives a first notification from the activation service indicating the edge device has been authenticated, and subsequently receives a second notification from a verification service indicating the authenticated edge device has been verified. Based on these first and second notifications, the network manager provides to the activation service a set of configuration data and a set of authentication data to enable the edge device to be added to the SD-WAN.

In some embodiments, the activation service is a slim activation service (i.e., holds a minimum amount of data) that acts as an intermediary between the edge device and the network manager to facilitate securely adding the edge device to the SD-WAN. The record, in some embodiments, is provided to the activation service in a periodic heartbeat call (e.g., a periodic outbound HTTP connection) to the activation service. In some embodiments, the record is one of multiple records associated with multiple edge devices created by the administrator, and each record provided to the activation service is staged such that not all edge records created in the network manager are provided to the activation service. In some embodiments, the record includes data for the activation service to authenticate, activate, and provide initial configuration to the edge device. The initial configuration, in some embodiments, enables the edge device to start performing a set of functions. At least one of these functions includes sending periodic heartbeat calls to the activation service to check for software updates and configuration changes, according to some embodiments.

The sets of configuration and authentication data enable the edge device to be added to the SD-WAN, in some embodiments, by enabling the edge device to establish a secure VPN (virtual private network) tunnel with an SD-WAN gateway device that has an exclusive route to the network manager of the SD-WAN. In some embodiments, all communications between the edge device and the network manager must be passed through the gateway device. Also, in some embodiments, the gateway device is a partner gateway device that is managed by the network manager, and deployed and configured for communications between devices of the SD-WAN and the network manager. The partner gateway, in some embodiments, is configured to only allow connections from authenticated edge devices, and to deny connections from unauthenticated devices that are not part of SD-WAN.

In some embodiments, upon receiving the first notification, and prior to receiving the second notification, the record for the edge device is updated within the network manager in order for a network administrator that acts as a verification service to review and verify the authenticated edge device. The network administrator, in some embodiments, manually verifies the authenticated edge device based on an explicit request by the network manager, while in other embodiments, the receipt of the first notification and/or the updating of the record includes an implicit request for the network administrator to verify the authenticated edge device. In some embodiments, the second notification indicating the authenticated edge device has been verified also indicates that the edge device has been approved to be added to the SD-WAN. Based on the verification and approval, the network manager then sends the configuration and authentication data sets to the activation service for enabling the edge device to be added to the SD-WAN by establishing a connection with the partner gateway device.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates a workflow diagram 100 for securely adding a new SD-WAN edge device to a secure virtual network, in some embodiments.

FIG. 2 illustrates a process of some embodiments for adding an edge device to an SD-WAN.

FIG. 3 illustrates a process performed by an edge device, in some embodiments, that is being added to an SD-WAN.

FIGS. 4A-4C conceptually illustrate a virtual network before a new edge device has been approved to be added to the SD-WAN, after the new edge device has been approved and added to the SD-WAN, and before a second new edge device has been approved and added to the SD-WAN, accord to some embodiments.

FIG. 5 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for a network manager (e.g., SD-WAN orchestrator from VMware, Inc.) of a secure SD-WAN (software-defined wide-area network) to securely add an edge device, which operates at a branch location in a public network, to the SD-WAN. The SD-WAN enables high performance and reliable branch network access across multiple different clouds and applications. To an activation service hosted on the public network and acting as an intermediary between the edge device and the network manager, the network manager provides a record for the edge device that is to be added to the SD-WAN securely, the record for use by the activation service to authenticate the edge device. The network manager receives a first notification from the activation service indicating the edge device has been authenticated, and subsequently receives a second notification from an administrator of the SD-WAN indicating the authenticated edge device has been verified. Based on these first and second notifications, the network manager provides to the activation service a set of configuration data and a set of authentication data to enable the edge device to be added to the SD-WAN.

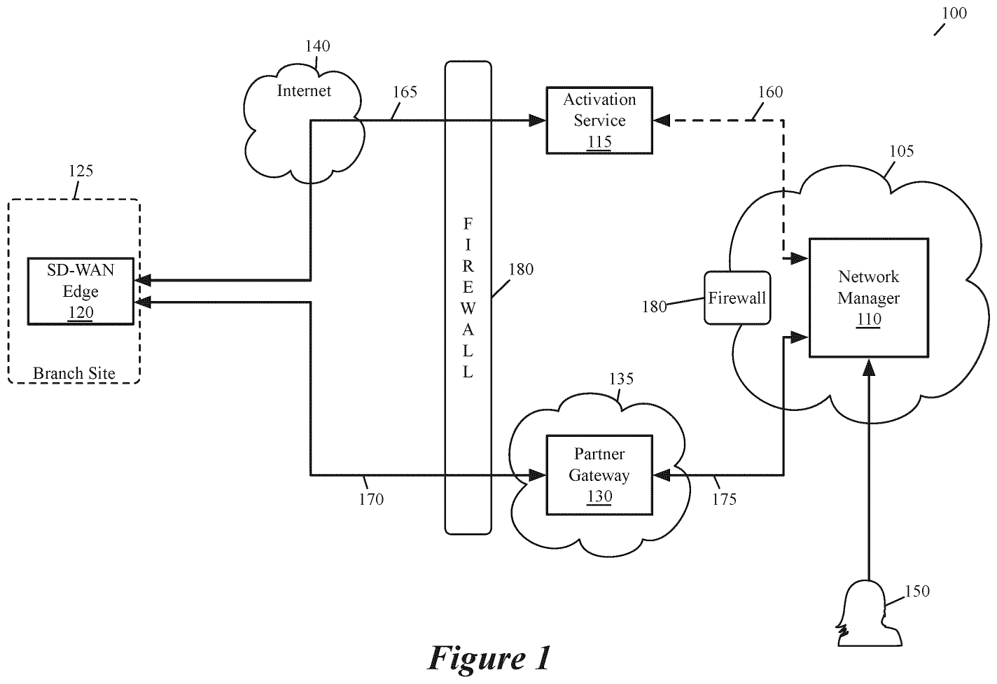

FIG. 1 conceptually illustrates a workflow diagram 100 for securely adding a new SD-WAN edge device to a secure virtual network, in some embodiments. The secure virtual network is created for a particular entity using SD-WAN forwarding elements deployed at branch sites, datacenters, and public clouds. Examples of public clouds are public clouds provided by Amazon Web Services (AWS), Google Cloud Platform (GCP), Microsoft Azure, etc., while examples of entities include a company (e.g., corporation, partnership, etc.), an organization (e.g., a school, a non-profit, a government entity, etc.), etc. In this example, the edge 120, the partner gateway 130, the network manager 110, and the secure connections 170 and 175 between them forms the virtual network for the particular entity that spans at least the public or private cloud datacenter 135 to connect the branch site 125 to the private cloud datacenter 105 that hosts the network manager 110.

The SD-WAN forwarding elements involved in the workflow diagram 100 include the partner gateway 130 and the SD-WAN edge 120. The partner gateway 130, in some embodiments, is a forwarding element that is in a private or public datacenter 135 and that is deployed and configured to only allow connections from authenticated edges. In some embodiments, additional SD-WAN gateways may be present and can include multi-tenant, stateless service gateways deployed in strategic points of presence (PoPs) across the globe. Some such gateways serve as gateways to various clouds and datacenters. The partner gateway 130 includes a secure connection link 175 (e.g., secure tunnel) with the network manager 110 (i.e., the orchestrator). Once the edge 120 has been authenticated, verified, and approved, the partner gateway 130 also includes a secure connection link 170 (e.g., a VPN tunnel) with the edge 120 at the branch site 125. These secure connection links, in some embodiments, each include multiple secure connection links (e.g., multiple secure tunnels that are established over multiple physical links).

When multiple such links are defined between an edge node and a gateway, each secure connection link in some embodiments is associated with a different physical network link between the edge node and an external network. For instance, to access external networks, an edge node in some embodiments has one or more commercial broadband Internet links (e.g., a cable modem, a fiber optic link) to access the Internet, an MPLS (multiprotocol label switching) link to access external networks through an MPLS provider's network, a wireless cellular link (e.g., a 5G LTE network), etc. In some embodiments, the different physical links between the edge node 120 and the partner gateway 130 are the same type of links (e.g., are different MPLS links).

In some embodiments, other SD-WAN forwarding elements include additional edge devices located at other branch sites of the entity, as well as SD-WAN hub forwarding nodes that can be used to connect to other edge forwarding nodes of other branch sites (not shown) to each other, as well as to resources at a datacenter that hosts the hub forwarding node. Hub forwarding nodes, in some embodiments, use or have one or more service engines to perform services (e.g., middlebox services) on data messages that it forwards from one branch site to another branch site.

The branch site 125, in some embodiments, is a multi-machine site of the entity. Examples of multi-machine sites of some embodiments include multi-user compute sites (e.g., branch offices or other physical locations having multi user computers and other user-operated devices and serving as source computers and devices for requests to other machines at other sites), datacenters (e.g., locations housing servers), etc. These multi-machine sites are often at different physical locations (e.g., different buildings, different cities, different states, etc.).

The network manager 110, in some embodiments, is a cluster of network managers and controllers that serve as a central point for managing (e.g., defining and modifying) configuration data that is provided to the edge nodes and/or gateways to configure some or all of the operations. In some embodiments, this network manager 110 is in one or more public cloud datacenters, while in other embodiments it is in one or more private datacenters. In this example, the network manager 110 sits behind a firewall 180 in a secure, private cloud datacenter #105. In some embodiments, the network manager 110 has a set of manager servers that define and modify the configuration data, and a set of controller servers that distribute the configuration data to the edge forwarding elements (FEs), hubs and/or gateways. In some embodiments, the network manager 110 directs edge forwarding elements (as well as hubs (not shown)) to use certain gateways (i.e., assigns a gateway to the edge forwarding elements and hubs). For instance, the network manager 110 assigns the edge 120 to the partner gateway 130.

The workflow diagram 100 also includes an activation service 115. In some embodiments, the activation service 115 is a slim activation service that acts as an intermediary between the edge device and the network manager to facilitate securely adding the edge device to the SD-WAN. By nature, the slim activation service 115, in some embodiments, only hosts a minimum amount of data to authenticate, activate, and push initial configuration to the edge 120. As a result, the slim activation service 115 can be hosted by a public network (e.g., the Internet 140) without exposing critical data to potential attacks. Additionally, the activation service 115 having limited data enables edge devices to be activated and used from any location in the world without having to expose the network manager 110 over a public network (e.g., the Internet), according to some embodiments. For further protection from potentially malicious entities while new edges are on-boarded to the secure virtual network, the activation service 115, as well as the partner gateway 130, sit behind a firewall 180 in some embodiments, as shown.

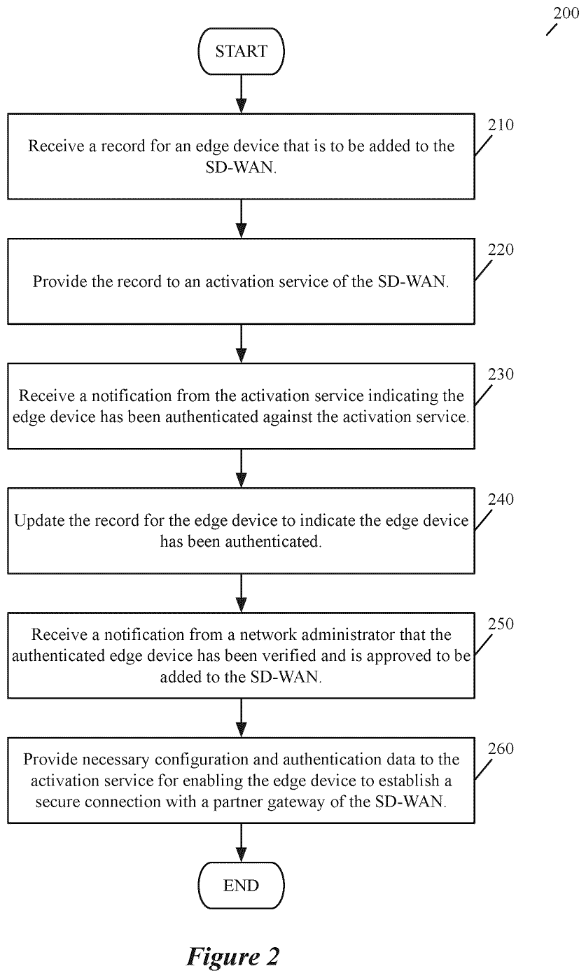

Additional details regarding the workflow diagram 100 will be further discussed below with reference to FIG. 2, which illustrates a process of some embodiments for adding an edge device to an SD-WAN. The process 200 is performed by an SD-WAN orchestrator, in some embodiments, such as the network manager 110.

The process 200 starts by receiving (at 210) a record for an edge device that is to be added to the SD-WAN (i.e., added to an entity's secure virtual network). For instance, the network manager 110 in the workflow diagram 100 receives data, such as a record for adding the edge device 120 to the SD-WAN, from the network administrator 150. In some embodiments, the record includes edge device details for the edge that is to be added to the SD-WAN, and the network manager 110 stores the record with other records for edge devices that have been added to the SD-WAN.

The process provides (at 220) the record to an activation service of the SD-WAN. For instance, the network manager 110, in some embodiments, provides the record activation service 115 via the secure connection link 160 between the network manager and activation service. The trust between the network manager and activation service is established, in some embodiments, using PKI (public key infrastructure) certificates. In some embodiments, the network manager provides the record to the activation service in a periodic heartbeat call (e.g., a periodic outbound HTTPS connection) to the activation service.

In addition to edge device details, the record provided to the activation service also includes data for the activation service to authenticate, activate, and provide initial configuration to the edge device, according to some embodiments. In some embodiments, a branch administrator (not shown) for the branch site 125 is possesses an activation key and an activation URL that identifies the activation service 115 for activating and authenticating the edge device 120. The branch administrator uses the activation key and activation URL to activate and authenticate the edge 120, in some embodiments and, in response, the activation service 115 then provides to the edge 120 a public profile and a temporary certificate (i.e., the initial configuration). This initial configuration, in some embodiments, enables the edge device to start performing a set of functions, such as sending periodic heartbeat calls to the activation service to check for software updates and configuration changes while the edge device waits to be approved and added to the SD-WAN.

The process then receives (at 230) a notification from the activation service indicating the edge device has been authenticated. For instance, the network manager 110 receives such notifications from the authentication service 115 via the connection 160. In some embodiments, this notification includes an updated record specifying that the edge has been activated and authenticated against the activation service.

The process then updates (at 240) the record for the edge device to indicate the edge device has been authenticated. The network manager 110, in some embodiments, updates the record based on information the notification. In other embodiments, such as when the notification includes an updated record, the network manager simply replaces its stored record with the received updated record for the edge. In some embodiments, upon receiving and updating the edge's record, the network manager 110 explicitly requests for the network administrator 150 to manually verify and approve the authenticated edge device, while in other embodiments, the receipt of the notification and/or the updating of the stored record includes an implicit request for the network administrator to verify and approve the authenticated edge device.

Accordingly, the process receives (at 250) a notification from a network administrator that the authenticated edge device has been verified and is approved to be added to the SD-WAN. The network manager 110, for instance, receives such notifications from the network administrator 150. In some embodiments, the network administrator acts as a verification service to verify and approve the edge by verifying the edge's identity as indicated by the updated record. In other embodiments, an automated process (e.g., a program) provides the verification service.

In response to the received verification and approval, the process provides (at 260) necessary configuration and authentication data to the activation service for enabling the edge device to establish a secure connection with a partner gateway of the SD-WAN. The sets of configuration and authentication data enable the edge device to be added to the SD-WAN, in some embodiments, by enabling the edge device to establish a secure VPN (virtual private network) tunnel with an SD-WAN gateway device that has an exclusive route to the network manager of the SD-WAN. For instance, the edge device 120 uses the sets of configuration and authentication data to establish a secure VPN connection 170 with the partner gateway device 130. In some embodiments, all communications between the edge device and the network manager must pass through the partner gateway. Following 260, the process 200 ends.

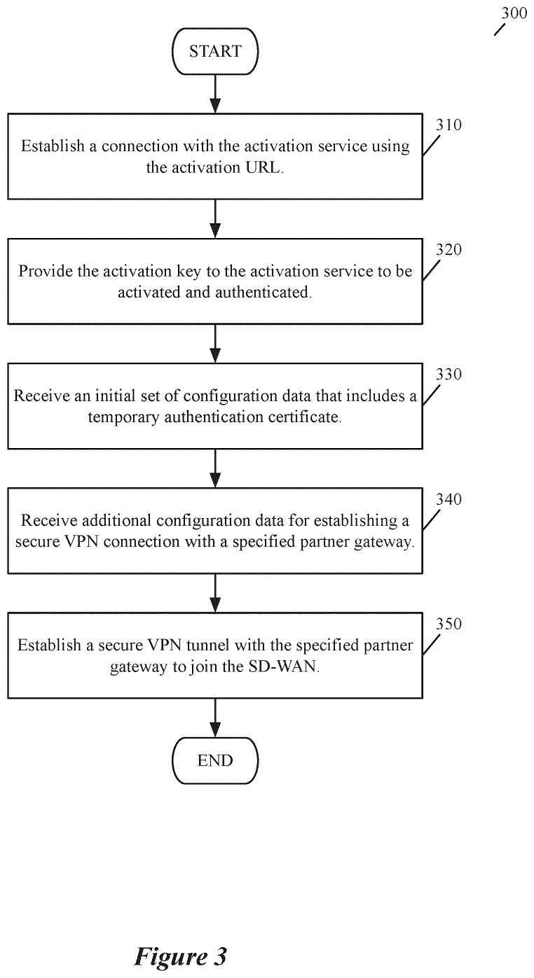

FIG. 3 illustrates a process performed by an edge device, in some embodiments, that is being added to an SD-WAN. As mentioned above, an administrator for the branch site at which the edge device is to be deployed possesses an activation key and activation URL that identifies the activation service. For instance, an employee for an entity may be issued an edge device to enable the employee to access the entity's network from the employee's home, in some embodiments. In some such embodiments, the employee would be provided with the activation key and activation URL required to securely activate the edge device from home and securely establish a connection to the entity's SD-WAN.

The process 300 starts by establishing (at 310) a connection with the activation service using the activation URL. For instance, the edge 120 described above would establish the connection 165 with the activation service 115 using such an activation URL (i.e., an administrator would use the URL to establish the connection between the edge and activation service), according to some embodiments.

The process provides (at 320) the activation key to the activation service to be activated and authenticated. That is, after the connection 165 has been established between the edge 120 and the activation service 115, the edge 120 (i.e., a branch administrator for the branch 125 via the edge 120) would provide the activation key to the activation service 115 via the established connection 165. The activation key, in some embodiments, is a particular software-based key (e.g., a product key or a software key), is a that certifies that the edge device being activated is original. In some embodiments, the key is a device-specific series of numbers and letters.

The process receives (at 330) an initial set of configuration data that includes a temporary authentication certificate. For instance, after providing the activation key, the edge is activated and authenticated against the activation service. When the activation and authentication are successful, the activation service, in some embodiments, provides to the edge initial configuration data that enables the edge device to begin periodically pinging the activation service to check for any software updates and/or configuration changes while the edge device is verified and approved by the orchestrator and network administrator.

The process receives (at 340) additional configuration data for establishing a secure VPN connection with a specified partner gateway. This additional configuration data is provided to the edge after the orchestrator has received confirmation from the network administrator that the edge device's identity has been verified, and the edge is now approved to join the SD-WAN. The orchestrator pushes the configuration to the activation service, which then provides the same to the edge.

The process then establishes (at 350) a secure VPN tunnel with the specified partner gateway to join the SD-WAN. For instance, the edge 120 establishes the VPN tunnel 170 with the partner gateway 130 in order to join the SD-WAN and being communicating with the network manager 110. Following 350, the process 300 ends.

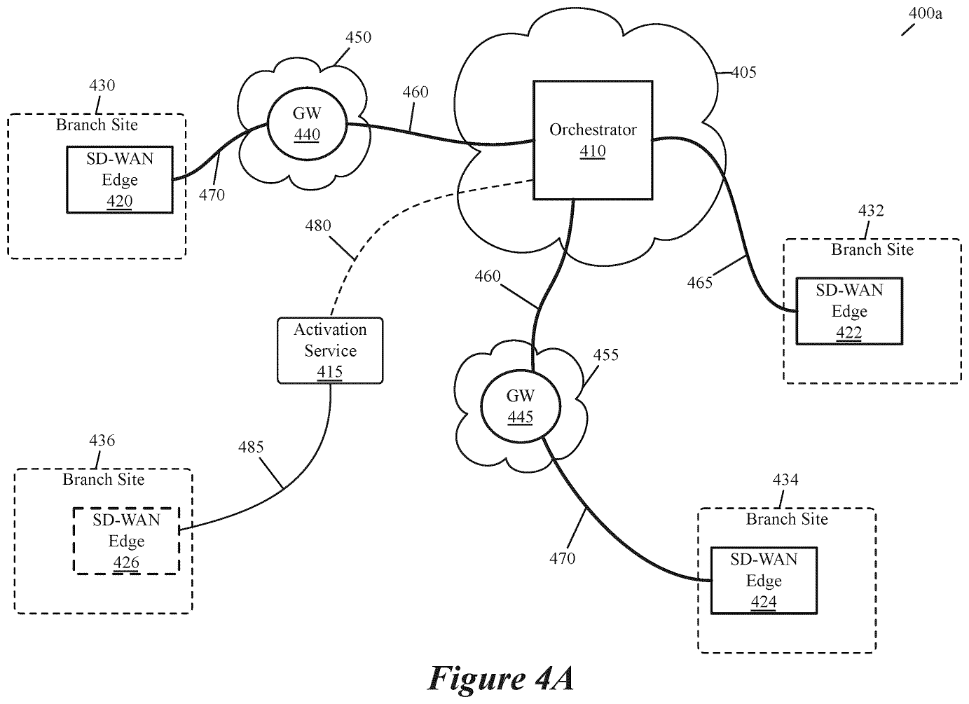

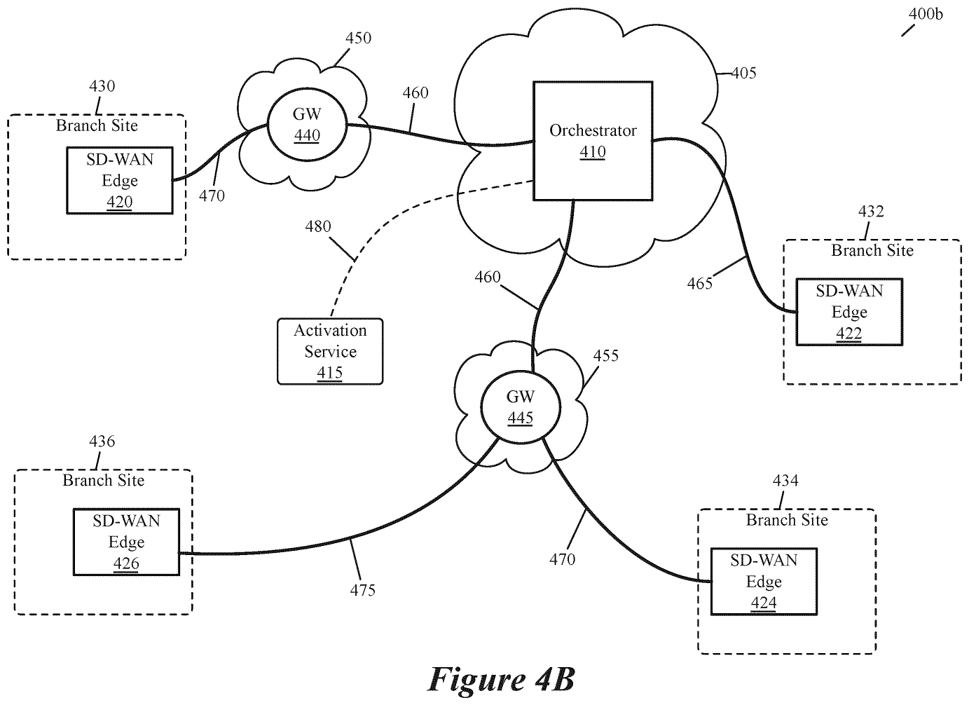

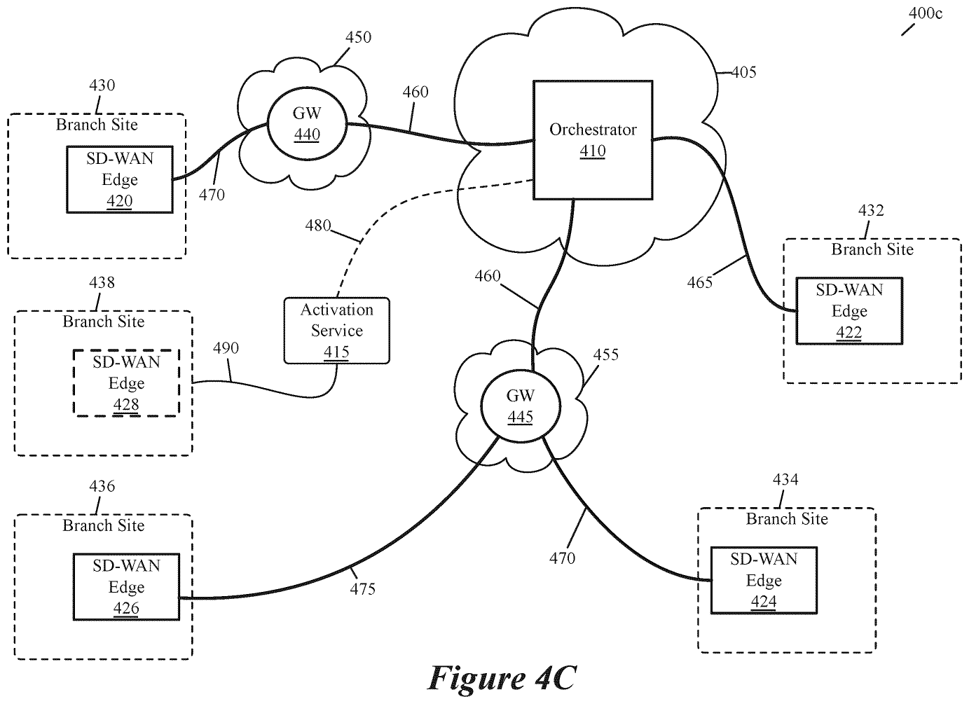

FIGS. 4A-4C conceptually illustrate a virtual network before a new edge device has been approved to be added to the SD-WAN, after the new edge device has been approved and added to the SD-WAN, and before a second new edge device has been approved and added to the SD-WAN, accord to some embodiments. The virtual network 400a of FIG. 4A includes multiple SD-WAN edges 420, 422, and 424, gateways 440 and 445, and an orchestrator 410 (i.e., network manager). The edges 420-424 are respectively hosted by branch sites 430, 432, and 434.

As shown, the edge 422 at the branch site 432 has a direct connection 465 to the orchestrator 410, which resides in the secure private cloud datacenter 405. The edges 420 and 424 at the branch sites 430 and 434 connect to respective gateways 440 and 445 via secure connection links 470 (e.g., VPN tunnels). Like the partner gateway 130, the gateways 440 and 445 are forwarding elements located in private or public datacenters 450 and 455, respectively. Also like the partner gateway 130, each of the gateways 440 and 445 has an exclusive connection 460 to the orchestrator 410. While the gateways in this example are illustrated as partner gateways that only connect edges within the virtual network 400a to the orchestrator 410, other embodiments also include multi-tenant gateways that connect various forwarding devices to various other forwarding devices and resources.

A new SD-WAN edge device 426 at the branch site 436 is also shown. Unlike the edges 420-424, the edge device 426 is yet to be added to the SD-WAN (as indicated by the dashed outline of the edge 426). Instead, the edge 426 includes a connection 485 to an activation service 415 that is managed by and connected to the orchestrator 410 via connection link 480. As described above, the activation service 415 is deployed in a public network and enables edge devices like edge device 426 to be securely added to the SD-WAN without exposing the orchestrator 410 or any critical information to the public network.

To add the edge device 426 to the SD-WAN, the orchestrator 410 uses the process 200 described above, according to some embodiments. FIG. 4B conceptually illustrates the virtual network 400b after the edge 426 has been added to the SD-WAN. As shown, the edge device 426 now includes a VPN tunnel 475 to the gateway 445, and no longer includes a connection to the activation service 415. In some embodiments, after the edge device 426 is successfully added to the SD-WAN, the activation service 415 removes all data associated with the edge 426 from its memory to further prevent exposing any information on the public network, and to prepare for any potential additional edges that are to be added using the activation service 415.

While the edge device 426 is illustrated as being connected to the orchestrator 410 via the gateway 445, the gateway 445 in other embodiments passes the secure VPN tunnel established by the edge device 426 to the orchestrator 410 to allow direct communications between the edge 426 and orchestrator 410, such as the direct connection 465 between the edge 422 and the orchestrator 410. In some embodiments, the gateway devices continue to provide edge devices with routes to the orchestrator, such as when no direct route between an edge and the orchestrator exist.

In FIG. 4C, the edge 426 still has its established VPN tunnel 475 with the gateway 445. Additionally, the activation service 415 now has a connection 490 to another new edge device 428, at a branch site 438, that is to be onboarded and added to the SD-WAN. As mentioned above, the activation service 415 in some embodiments removes all data for an edge device after the edge has been successfully added to the SD-WAN. As such, the activation service 415 shown no longer includes data for the edge 426, and instead receives a new record and new data for the edge 428 from the orchestrator 410 and uses the connection 490 to activate and authenticate the new edge 428.

In some embodiments, once added to the SD-WAN, the new edge 428 may establish a secure VPN tunnel with one of the existing gateways 440 and 445 in order to begin communicating with the orchestrator 410. In other embodiments, a new gateway (not shown) may be deployed to provide the edge 428 a route to the orchestrator 410, such as when the edge 428 cannot reach one of the existing gateways 440 and 445.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

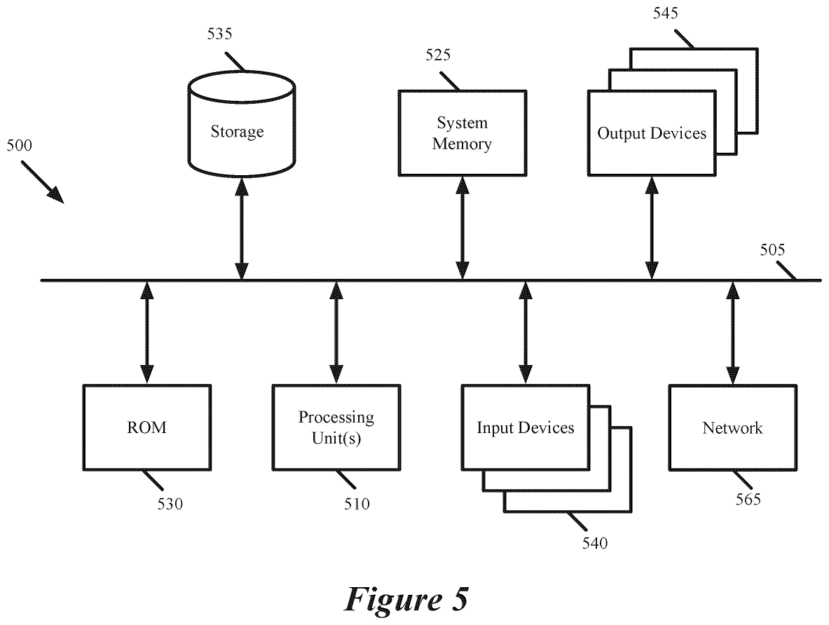

FIG. 5 conceptually illustrates a computer system 500 with which some embodiments of the invention are implemented. The computer system 500 can be used to implement any of the above-described hosts, controllers, gateway, and edge forwarding elements. As such, it can be used to execute any of the above described processes. This computer system 500 includes various types of non-transitory machine-readable media and interfaces for various other types of machine-readable media. Computer system 500 includes a bus 505, processing unit(s) 510, a system memory 525, a read-only memory 530, a permanent storage device 535, input devices 540, and output devices 545.

The bus 505 collectively represents all system, peripheral, and chipset buses that communicatively connect the numerous internal devices of the computer system 500. For instance, the bus 505 communicatively connects the processing unit(s) 510 with the read-only memory 530, the system memory 525, and the permanent storage device 535.

From these various memory units, the processing unit(s) 510 retrieve instructions to execute and data to process in order to execute the processes of the invention. The processing unit(s) 510 may be a single processor or a multi-core processor in different embodiments. The read-only-memory (ROM) 530 stores static data and instructions that are needed by the processing unit(s) 510 and other modules of the computer system 500. The permanent storage device 535, on the other hand, is a read-and-write memory device. This device 535 is a non-volatile memory unit that stores instructions and data even when the computer system 500 is off. Some embodiments of the invention use a mass-storage device (such as a magnetic or optical disk and its corresponding disk drive) as the permanent storage device 535.

Other embodiments use a removable storage device (such as a floppy disk, flash drive, etc.) as the permanent storage device. Like the permanent storage device 535, the system memory 525 is a read-and-write memory device. However, unlike storage device 535, the system memory 525 is a volatile read-and-write memory, such as random access memory. The system memory 525 stores some of the instructions and data that the processor needs at runtime. In some embodiments, the invention's processes are stored in the system memory 525, the permanent storage device 535, and/or the read-only memory 530. From these various memory units, the processing unit(s) 510 retrieve instructions to execute and data to process in order to execute the processes of some embodiments.

The bus 505 also connects to the input and output devices 540 and 545. The input devices 540 enable the user to communicate information and select commands to the computer system 500. The input devices 540 include alphanumeric keyboards and pointing devices (also called “cursor control devices”). The output devices 545 display images generated by the computer system 500. The output devices 545 include printers and display devices, such as cathode ray tubes (CRT) or liquid crystal displays (LCD). Some embodiments include devices such as touchscreens that function as both input and output devices 540 and 545.

Finally, as shown in FIG. 5, bus 505 also couples computer system 500 to a network 565 through a network adapter (not shown). In this manner, the computer 500 can be a part of a network of computers (such as a local area network (“LAN”), a wide area network (“WAN”), or an Intranet), or a network of networks (such as the Internet). Any or all components of computer system 500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1-20. (canceled)

21. A method for securely adding an edge device to a secure SD-WAN (software-defined wide-area network), the method comprising:
establishing an initial connection, by the edge device, with an activation service;
providing, by the edge device, an activation key to the activation service via the initial connection, wherein the activation service uses the activation key to authenticate the edge device;
after the edge device is authenticated by the activation service, receiving, by the edge device, an initial set of configuration data from the activation service, wherein the initial set of configuration data includes a temporary authentication certificate;
after the edge device's identity has been verified, receiving, by the edge device, additional configuration data from the activation service for establishing a secure connection with a specified gateway; and
establishing, by the edge device, the secure connection with the specified gateway to join the SD-WAN, wherein the specified gateway is configured to only allow connections from authenticated edge devices to the SD-WAN.

22. The method of claim 21, further comprising using the temporary authentication certificate to periodically ping the activation service to check for software updates while the edge device is verified.

23. The method of claim 21, further comprising using the temporary authentication certificate to periodically ping the activation service to check for configuration changes while the edge device is verified.

24. The method of claim 21, wherein the secure connection with the specified gateway is a virtual private network tunnel.

25. The method of claim 21, wherein the edge device operates at a branch location in a public network.

26. The method of claim 25, wherein the activation service is hosted on the public network.

27. The method of claim 21, wherein the activation service receives the additional configuration data from an orchestrator of the SD-WAN after the edge device has been verified and approved to join the SD-WAN.

28. A non-transitory computer-readable medium for securely adding an edge device to a SD-WAN (software-defined wide-area network), the non-transitory computer-readable medium comprising instructions executable by a processor at the edge device for:
establishing a connection with an activation service;
providing an activation key to the activation service via the connection, wherein the activation service uses the activation key to authenticate the edge device;
after the edge device is authenticated by the activation service, receiving an initial set of configuration data from the activation service, wherein the initial set of configuration data includes a temporary authentication certificate;
using the temporary authentication certificate to periodically ping the activation service while the edge device is verified;
after the edge device's identity has been verified, receiving, by the edge device, additional configuration data from the activation service for establishing a secure connection with a specified gateway; and
establishing, by the edge device, the secure connection with the specified gateway to join the SD-WAN, wherein the specified gateway is configured to only allow connections from authenticated edge devices to the SD-WAN.

29. The non-transitory computer-readable medium of claim 28, wherein the activation service is pinged to check for software updates.

30. The non-transitory computer-readable medium of claim 28, the activation service is pinged to check for configuration changes.

31. The non-transitory computer-readable medium of claim 28, wherein the secure connection with the specified gateway is a virtual private network tunnel.

32. The non-transitory computer-readable medium of claim 28, wherein the edge device operates at a branch location in a public network.

33. The non-transitory computer-readable medium of claim 32, wherein the activation service is hosted on the public network.

34. The non-transitory computer-readable medium of claim 28, wherein the activation service receives the additional configuration data from an orchestrator of the SD-WAN after the edge device has been verified and approved to join the SD-WAN.

35. A network device to be added to a secure SD-WAN (software-defined wide-area network) comprising:
a processor; and
a memory having stored thereon program code that, when executed by the processor, causes the processor to:
provide an activation key to an activation service, wherein the activation service uses the activation key to authenticate the network device;
after the network device is authenticated by the activation service, receive an initial set of configuration data from the activation service, wherein the initial set of configuration data includes a temporary authentication certificate;
after the network device's identity has been verified, receive additional configuration data from the activation service for establishing a secure connection with a specified gateway; and
establish the secure connection with the specified gateway to join the SD-WAN, wherein the specified gateway is configured to only allow connections from authenticated devices to the SD-WAN.

36. The network device of claim 35, wherein the processor is further caused to use the temporary authentication certificate to periodically ping the activation service to check for software updates while the network device is verified.

37. The network device of claim 35, wherein the processor is further caused to use the temporary authentication certificate to periodically ping the activation service to check for configuration changes while the network device is verified.

38. The network device of claim 35, wherein the secure connection with the specified gateway is a virtual private network tunnel.

39. The network device of claim 35, wherein the network device operates at a branch location in a public network.

40. The network device of claim 35, wherein the activation service receives the additional configuration data from an orchestrator of the SD-WAN after the network device has been verified and approved to join the SD-WAN.
